(19) United States
(12) Patent Application Publication
(10) Pub. No.: US 2020/0166382 A1
(43) Pub. Date: May 28, 2020

(54) OPTICAL ENCODER SYSTEM WITH SHAPED LIGHT SOURCE

(71) Applicant: TT Electronics PLC, Carrollton, TX (US)

(72) Inventors: Brent Hans Larson, Dallas, TX (US); Virgil Ararao, McKinney, TX (US); James P. Cusey, Dallas, TX (US)

(21) Appl. No.: 16/694,189

(22) Filed: Nov. 25, 2019

Related U.S. Application Data
(60) Provisional application No. 62/771,274, filed on Nov. 26, 2018.

(51) Int. Cl. G01D 5/347

(52) U.S. Cl. CPC G01D 5/34707; G01D 5/3473

(57) ABSTRACT

An optical encoder system includes: a light emitter configured to emit a light flux; a plurality of photodetectors in an array, wherein each photodetector is operable to generate a current in response to the light flux; and a target object positioned to reflect the light flux onto the plurality of photodetectors; wherein the light emitter is configured to produce a non-circular pattern of the light flux.

### CROSS-REFERENCE TO RELATED APPLICATION

The present application claims the priority benefit of U.S. Provisional Patent Application No. 62/771,274, filed Nov. 26, 2018, the disclosure of which is incorporated by reference in its entirety.

### TECHNICAL FIELD

The present description relates, in general, to apparatuses and techniques for optical encoder systems having shaped light sources.

### BACKGROUND

An encoder system, such as an optical encoder, may include an electro-mechanical device that detects and converts positions (e.g., linear and/or angular positions) of an object to analog or digital output signals by using one or more photodetectors. There are different types of encoders, such as rotary encoders and linear encoders. An exemplary encoder system usually uses a light source, a light modulator located in the source light pathway (e.g., a code disk), and an encoder chip (e.g., an optical sensor integrated circuit) including one or more photodetectors that receive the modulated light and generate electrical signals in response thereto.

Reflective optical encoders use a light emitting diode (LED) on the same side of a code disk as the encoder chip. The LEDs used have historically featured a circular emission resulting in a different optical power level at differing points on a measurement surface. Transmissive encoders have countered this effect over time by using a collimating lens over the LED to provide a more uniform light power level. Reflective solutions where the LED is included inside the encoder chip package do not typically have the option of a collimating lens due to the package height restrictions.

This circular emission provides a non-uniform light intensity on the code disk reflective slits which in turn impacts the resulting reflection on the encoder chip. This non-uniform field may not provide optimal results as the effective collection area of the photodetectors is reduced due to non-uniform power density.

### SUMMARY

It is therefore desirable to have systems and methods that avoid the disadvantages of circular emissions while preserving the small size constraints and cost efficiencies of reflective optical encoder systems. To that end, various embodiments of the present disclosure include a shaped light emitter in a reflective optical encoder.

For instance, a shaped light emitter may include a light-emitting diode (LED) or other light source that has a non-circular emission pattern. In one example, an LED is doped specifically to cause its emissions to be rectangular or elliptical rather than circular. In another example, an LED assembly includes a rectangular aperture structure that produces an elliptical emissions pattern. As another example, some embodiments may include an elliptical emission LED (EEL) as the light source for a reflective optical encoder.

A shaped light emitter providing a highly oblong emissions pattern may differ from a traditional point source LED which produces a circular emissions pattern. In one aspect, a point source LED produces a pattern that decreases in light intensity in two dimensions (i.e., the X dimension and Y dimension), as discussed in more detail with respect to FIG. 5. To the extent that radial falloff in an emissions pattern presents an engineering challenge, it is a two-dimensional phenomenon for the circular pattern. By contrast, a highly oblong light pattern may sometimes be approximated as a one-dimensional challenge, thereby decreasing complexity in the solution. Furthermore, a highly oblong emissions pattern with a one-dimensional falloff may be aligned with structures, such as slits in a code disk or pixels in a photo detector array, thereby providing more consistent light flux along a dimension of the structure to help ensure precision performance of the device.

Furthermore, in some instances light sources designed to produce highly oblong emissions patterns may be employed to preserve space. As noted above, shaped LEDs may be constructed using doping or apertures, both of which may be manufactured with negligible (or no) extra height added to the LED structure itself. This contrasts with a collimator lens, sometimes used with transmissive optical encoders, wherein the collimator lens may add significant height to the LED structure.

In one aspect of the disclosure, an optical encoder system includes a light emitter configured to emit a light flux. In this example, the light emitter is configured to produce a noncircular pattern of the light flux. Examples of noncircular patterns may include patterns that are approximately rectangular, elliptical, or other appropriate shape. For instance, an EEL may produce an elliptical pattern that behaves much differently than would a circular pattern of a point source LED. The optical encoder system may further include a plurality of photodetectors in an array, wherein each photodetector is operable to generate a current in response to the light flux. The optical encoder system may also include a target object positioned to reflect the light flux onto the plurality of photodetectors.

In another aspect of the disclosure, an optical encoder system includes means for emitting a light flux having a non-circular pattern. An example mentioned above includes an EEL to produce an elliptical emissions pattern. The optical encoder system may also include means for reflecting and encoding the light flux according to a plurality of spaced surface features. The reflecting and encoding means may include, e.g., a code disk or a linear code strip having reflective and non-reflective surface features arranged in a pattern to encode the light. The optical encoder system may also include means for generating electrical currents in response to detecting the encoded light flux, where examples include photodetectors arranged in an array. The optical encoder system may also include means for calculating motion or position in response to the generate electrical currents. For instance, the optical encoder system may include an integrated circuit chip such as an application-specific integrated circuit (ASIC) or other processing device that receives either the currents or voltages resulting from the currents and then calculates motion or position therefrom.

In yet another aspect of the disclosure, a method for operating an optical photodetector system includes generating light flux at a shaped light source and encoding the light flux using a plurality of spaced reflective and non-reflective surface features of a rotary code disk or linear code strip. The method may also include receiving the encoded light flux reflected from the rotary code disk or linear code strip and then generating a plurality of currents responsive to receiving the encoded light flux.

### BRIEF DESCRIPTION OF THE DRAWINGS

FIG. 1 is an illustration of an example reflective optical encoder according to one embodiment of the present disclosure.

FIG. 2 is an illustration of an example alternative reflective optical encoder according to one embodiment of the present disclosure.

FIG. 3 is an illustration of an example code disk with a plurality of slits for use in the reflective optical encoder according to an embodiment of the present disclosure.

FIG. 4 is an illustration of an example linear code strip with a plurality of slits for use in a reflective optical encoder according to an embodiment of the present disclosure.

FIG. 5 is an illustration of an example emission pattern for a point source LED.

FIG. 6 is an illustration of an example emission pattern for a point source LED superimposed on an arrangement of slits and photodetectors according to one embodiment.

FIG. 7 is an illustration of an example emission pattern that is non-circular and may be used with various reflective optical encoders according to one embodiment.

FIGS. 8A and 8B are an illustration of an example LED assembly to produce a non-circular emissions pattern according to one embodiment.

FIGS. 9A and 9B are an illustration of an example non-circular emission pattern superimposed on an arrangement of slits and photodetectors according to one embodiment.

FIG. 10 is an illustration of an example method for use of reflective optical encoder with a light source having a non-circular emission pattern according to one embodiment.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. Any alterations and further modifications to the described devices, systems, methods, and any further application of the principles of the present disclosure are fully contemplated as would normally occur to one having ordinary skill in the art to which the disclosure relates. For example, the features, components, and/or steps described with respect to one embodiment may be combined with the features, components, and/or steps described with respect to other embodiments of the present disclosure to form yet another embodiment of a device, system, or method according to the present disclosure even though such a combination is not explicitly shown. Further, for the sake of simplicity, in some instances the same reference numerals are used throughout the drawings to refer to the same or like parts.

The present disclosure is generally related to optical detection systems and methods, more particularly to an optical encoder with a shaped light source and methods for operation of the encoder system. Various embodiments described herein may use a code wheel (for rotary encoders) as an example of a target object. The principles in the present disclosure can also be used for detecting linear movements (e.g., by a code strip for linear encoders), and the scope of embodiments may include any suitable optical detection of moving objects.

FIG. 1 is an illustration of an encoder system 100, adapted according to one embodiment. The encoder system of FIG. 1 is a reflective encoder system, including integrated circuit chip 104, LED assembly 106, and target object 102. In this example, LED assembly 106 produces light, which is directed toward the target object 102. The target object 102 includes a plurality of reflective and non-reflective surface structures, and motion of the target object 102 encodes the light according to the surface structures. Thus, the reflected light is encoded and received by a photodetector array on surface 108 of integrated circuit chip 104. The photodetector array includes light-sensitive structures, such as photodiodes, which produce current in response to receiving light. Integrated circuit chip 104 may include a variety of different amplifiers, filters, and other circuitry to provide currents and/or voltages indicative of a motion phenomenon observed at target object 102. The currents and/or voltages may be translated into digital data and analyzed according to one or more algorithms using processing circuitry within integrated circuit chip 104.

FIG. 1 is offered to show an embodiment in which the LED assembly 106 is mounted upon the integrated circuit chip 104. In some examples, the LED assembly 106 may be mounted to the side of the photodetector array or may be mounted within an area of the photodetector array so that the LED assembly 106 is surrounded on some or all sides by photodetectors.

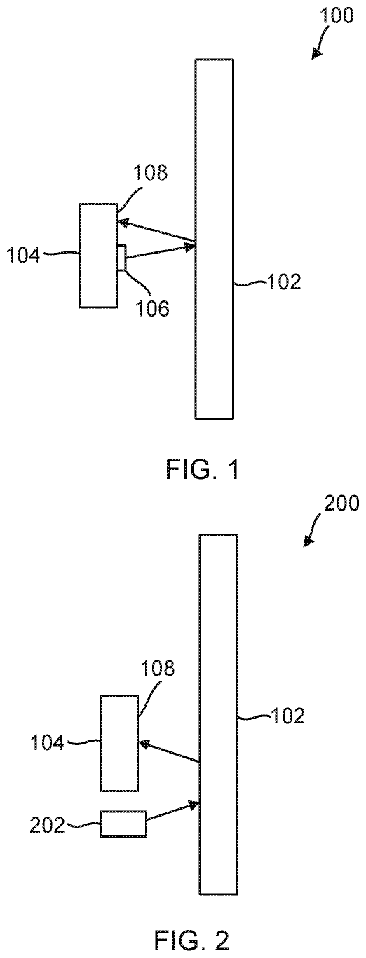

By contrast, the embodiment of FIG. 2 illustrates an example embodiment 200 in which an LED assembly 202 is disposed on one side of the integrated circuit chip 104. For instance, the integrated circuit chip 104 and the LED assembly 102 may be included in the same chip package or in separate chip packages mounted on a common substrate, such as a printed circuit board (PCB).

FIGS. 1 and 2 both illustrate profile views of reflective encoder systems 100 and 200. In the embodiments of FIGS. 1 and 2, the respective LED assemblies 106 and 202 are on the same side of the target object 102 as the IC chip 104 and photodetectors, and the light path goes from the LED assemblies 106/202 to the reflective target object 102 to the photodetectors on surface 108. This contrasts to a transmissive approach (not shown) where an LED is on the opposite side of the target object as the detector. As noted above, the LED either is placed on top of the IC chip 104 (FIG. 1) or adjacent to IC chip 104 (FIG. 2). When placed on top of the IC chip 104, encoder system 100 may embody the LED assembly 106 as an LED die with a wire bond. Furthermore, in the examples described herein, the LED assemblies 106/202 may include shaped light sources, such as an EEL.

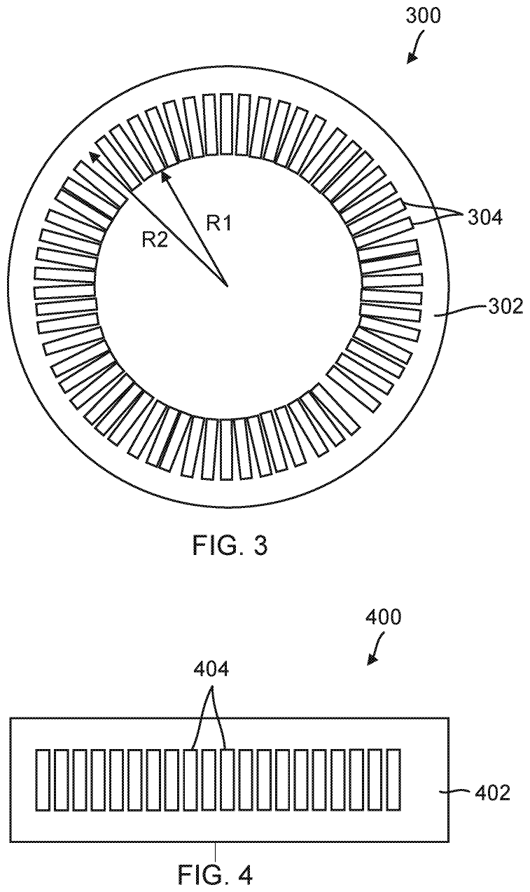

One example of an optical encoder system is an incremental encoder that is used to track motion and can be used to determine position and velocity. This can be either linear or rotary motion. Because the direction can be determined, accurate measurements can be made. FIG. 3 depicts an embodiment of a reflective rotary code disk that can be used in the systems of FIGS. 1 and 2. Within FIG. 3, the region of the code disk 300 with alternating reflective and non-reflective surface features has a multitude of “tracks.” As an example, the items labeled 304 may be reflective portions, and the background material 302 may be opaque and non-reflective. However, in other embodiments that may be reversed.

Continuing with this example, a track is the set of the points on the code disk whose distance from the center is between an inner radius R1 and an outer radius R2, and the non-reflective (e.g., bars) and reflective (e.g., slits) regions of the track are arranged such that the track has discrete rotational symmetry of order N about the center, where N≥1. One such track on an incremental encoder is known as the quadrature track, whose order of rotational symmetry is termed the pulses per revolution (PPR) of the encoder system. When applied to the examples of FIGS. 1 and 2, the code disk 300 of FIG. 3 would be placed as shown and rotated about it center using a shaft (not shown), and the light from the LED assemblies 106/202 would be directed at the tracks and reflect from the tracks to the photodetectors on surface 108. The reflected light is encoded according to the motion of the code disk 300, as the reflective and non-reflective areas either reflect or absorb the light.

FIG. 4 provides a similar example to that of FIG. 3. Specifically, FIG. 4 provides an example linear code strip 400, according to one embodiment. Linear code strip 400 also includes reflective and non-reflective areas to create tracks, and two of those reflective areas (slits) are marked as items 404. The background material 402 may be opaque and non-reflective, although in some embodiments, the items 404 may be opaque and non-reflective, whereas the background material 402 may be reflective. In any event, linear code strip 400 may be applied in the examples of FIGS. 1 and 2 so that the tracks are illuminated by the LED assemblies 106/202 and the reflected, encoded light is received at the surface 108 having the photodetectors.

To add perspective to the embodiments of FIGS. 1 and 2, using current manufacturing processes, the distance between the target object 102 and the LED assemblies 106/202 may be about 300 μm. However, different technologies may be used in other embodiments, and the scope of embodiments is not limited to any particular distance or dimension. This contrasts with some example collimator lenses that may be used with transmissive systems, where those example collimator lenses may have a height of 5 mm. In other words, some collimator lenses may be an order of magnitude larger in height than a distance between an LED assembly and a target object. This illustrates an advantage of using a reflective optical encoder—the reflective optical encoder may provide some amount of space savings compared to a transmissive optical encoder. Various embodiments herein may employee a shaped light emitter at LED assemblies 106/202 to enhance precision with no, or little, additional cost or size.

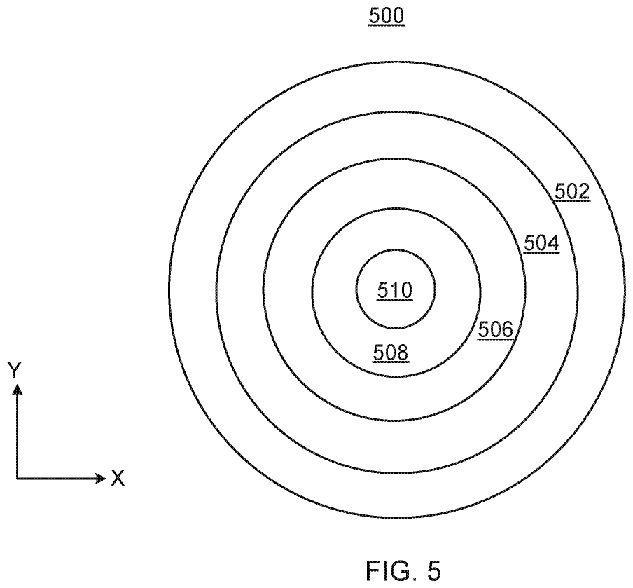

FIG. 5 is an illustration of an emissions pattern 500 of an example point source LED, according to one embodiment. Or put another way, FIG. 5 shows a typical optical output profile for a bare LED die. Light is emitted in all directions with varying intensity, most often falling off as a function of distance from the center. In the example of FIG. 5, the light intensity goes from strongest at area 510 to weakest at area 502. It should also be noted that a real-world light pattern for a point source LED would have continuous radial falloff, which is illustrated approximately with the discrete rings 502-510. Also, the radial falloff happens in two dimensions, illustrated in FIG. 5 as the X and Y axes.

Transmissive systems often deal with the non-uniform light by applying a collimating lens over the LED to provide a more uniform light profile. For example, a 4 mm diameter lens may be applied to provide an optical source with a uniform light profile over the 4 mm diameter and ideally no light emitted outside of the 4 mm diameter. This approach works for a transmissive application since the distance from the code disk to the LED is generally large compared with the distance from the code disk to the detector chip. However, as noted above, such solution may not be viable for some reflective optical encoder systems.

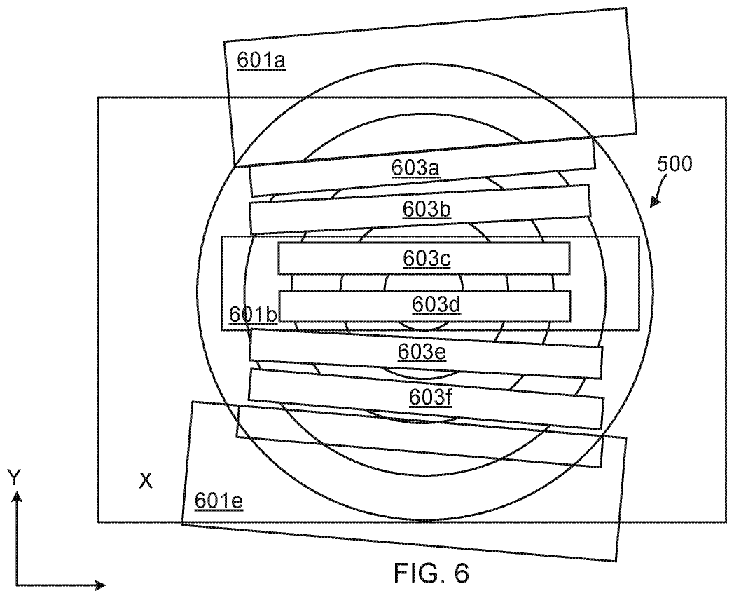

FIG. 6 shows an illustration of a reflective system using a bare LED (a point source), with the emissions pattern 500 (FIG. 5) superimposed to illustrate radial falloff in an example reflective system. The large rectangles 601 represent the slits in the code disk (e.g., code disk 300 of FIG. 3), and the small rectangles 603 represent the photodetectors on surface 108 of the IC chip 104.

FIG. 6 shows an overlap of the LED intensity profile with the code disk and the detector array. Note that the light intensity profile varies across photodetectors 603, both in the X direction (especially for detectors approximately aligned with the X axis) and across multiple detectors in the Y direction. This light profile is non-uniform resulting in varying input optical power on the detectors 603 and subsequently different optical power on the downstream amplifiers. This may reduce the effectiveness of the detector circuit since the photodetectors see an especially weak intensity as distances in both the X and Y axes increase from the center. This may be compensated somewhat by additional amplification. Lower signal levels may have a ripple effect on overall signal quality and thus performance of the resulting system.

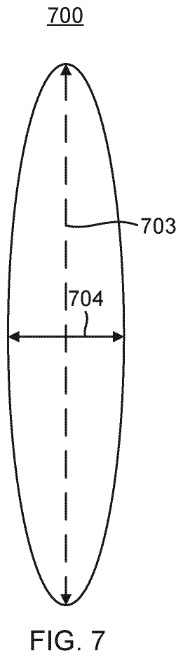

Various embodiments dispense with the bare LED associated with emissions pattern 500 and instead use a shaped light source providing an emissions pattern the same as or similar to emissions pattern 700 of FIG. 7. Emissions pattern 700 is highly oblong, with major dimension 703 being longer than minor dimension 704. In some examples, major dimension 703 may be three or more times as long as minor dimension 704, thereby creating a stretched-out shape favoring the major dimension. Emissions pattern 700 is shown in this example as an ellipse because diffraction effects of a rectangular LED aperture are generally expected to produce an ellipse rather than a rectangle, at least at a distance that would be expected between the LED assembly and the target object in a reflective encoder.

A feature of emissions pattern 700 is that radial falloff in the major dimension may be approximated as zero in some embodiments. For instance, in embodiments in which a major dimension of the emissions pattern 700 is about as long as, or longer than, a slit or a detection circuit (e.g., a photodetector or group of photodetectors), the radial falloff in the major dimension may be negligible when compared to radial falloff in the minor dimension. As a result, some embodiments may effectively have one-dimensional power variation over a set of photodiodes, thereby increasing precision and performance by directing a consistent light flux at relevant photodiodes.

Additionally, some embodiments may include a programmable set of photodiodes, where each of the photodiodes is programmable to one of four quadrature states or OFF. The assignments of the photodiodes may be applied by a network of multiplexers that receive an instruction bitmap to route current from a particular photodiode to a particular bus. Assignments of the photodiodes may be determined by simulation and/or experimentation so that the output of the photodiode array as a whole is close to an idealized set of four sinusoids of equal amplitude and offset by 90 degrees. Furthermore, the shape and phases of the sinusoids may be further fine-tuned by determining and applying weights to some or all of the individual photodiodes through use of summing and amplification. Appropriate summing and amplification may also be determined by simulation and/or experimentation. Examples of assigning photodiodes to different quadrature states and also applying weights may be found at Ser. No. 15/681,182; 62/755,658; and 62/729,474, the contents of which are incorporated by reference herein in their entirety.

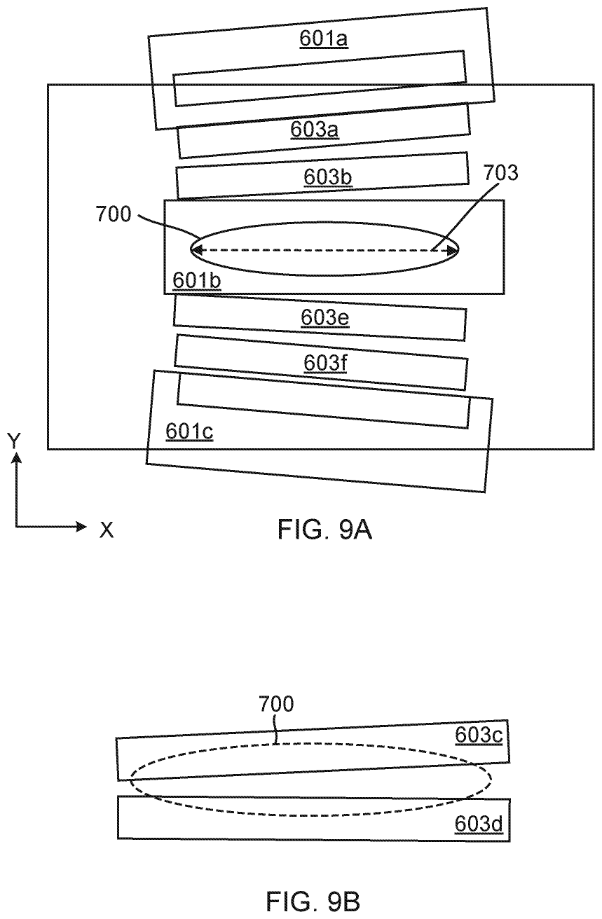

However, radial falloff from a point source LED may complicate the calculations for simulation and experimentation and cause imprecision, or establish a ceiling on precision, because some of the photodiodes would be expected to see much less light intensity than would other photodiodes of the same array, and the differences photodiode-to-photodiode would be two dimensional over the array. By contrast, various embodiments of the disclosure may reduce or effectively eliminate the radial falloff along the major dimension 703, decreasing the complexity of the simulation calculations, and thereby increasing precision of the system. The increase in precision is further illustrated and discussed with respect to FIG. 9A.

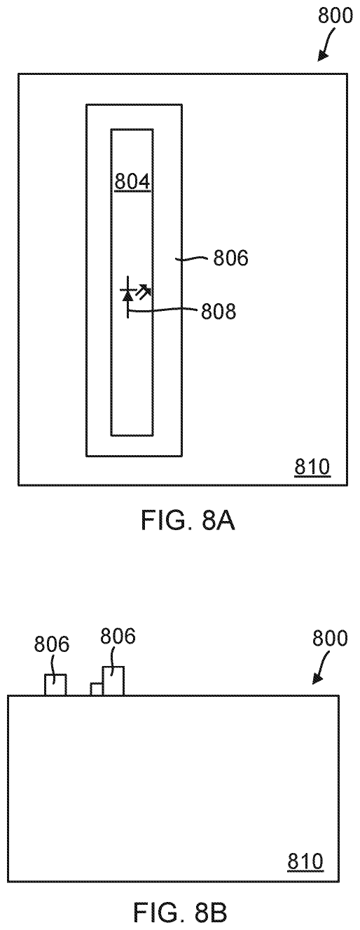

FIGS. 8A and 8B are a top down view and side view, respectively, for an example LED assembly 800 to produce the emissions pattern 700, according to one embodiment. For instance, LED assembly 800 may be used in the systems illustrated in FIGS. 1 and 2 as LED assemblies 106/202. Instead of the typical circular pattern used for LEDs, the top surfaces of an LED assembly can be constructed with varying materials to concentrate optical power along a rectangular shape. FIGS. 8A and 8B illustrate how different deposition layers can help affect this shape. In FIGS. 8A and 8B, LED assembly 800 may be constructed of any appropriate material, where material 810 may include layers of silicon or other appropriate semiconductor, some of the layers being doped to create a p-n junction diode, as well as insulators and conductors to route current. Structures 806 may be made of any appropriate material that may absorbs some light and may be formed using appropriate semiconductor deposition processes, such as silicon or masking material. Structures 806 are formed at or near a top portion of the substrate.

As shown in the top down view of FIG. 8A, structures 806 form a rectangular shape with an aperture 804. The aperture 804 exposes the light-emitting diode 808 so that light from LED 808 shines out from aperture 804. The rectangular shape of structures 806 affects the shape of the light emitted from LED assembly 800. As noted above, while the aperture may be rectangular, diffraction effects are generally expected to create an elliptical or approximately elliptical shape of the emission pattern, as exemplified by emission pattern 700.

This example has been described in terms of structures formed by semiconductor deposition processes. Other techniques may be used to provide this shape as well. A non-deposition approach to creating a shaped output would be to apply a non-transparent aperture to the top of the LED. One technique would be to use a metal cover with an opening in the desired rectangular shape. A glass wafer with metal film in proper places may achieve this, where the metal film forms a metal covering with an opening in the desired rectangular shape above the LED. In fact, for wafer processing, there may be a multitude of LEDs in a bottom wafer, and the glass wafer with the metal film put on top may include a multitude of apertures, each corresponding to one of the LEDs, and the glass layer may be bonded to the LED wafer before singulation. Of course, the scope of embodiments is not limited to any particular process to build a shaped light-emitting device, such as an EEL.

FIG. 9 is an illustration of exemplary emissions pattern 700 superimposed on the arrangement of slits and photodetectors according to one embodiment and similar to the example discussed above at FIG. 6. A difference between FIG. 9 in FIG. 6 is at FIG. 9 illustrates a non-circular emissions pattern. Furthermore, FIG. 9 is broken into FIG. 9A and FIG. 9B, with FIG. 9B providing more detail for the alignment of the emissions pattern 700 with respect to photodetectors 603c,d under the slit 601b. The photodetectors 603 represent a subset of photodetectors which may be included in an array of photodetectors on surface 108 in the systems of FIGS. 1 and 2.

In FIG. 9, the major axis 703 of the emissions pattern 700 is approximately aligned with a length dimension of the slit 601B and with the photodiodes 603c and 603d. Or put another way, the major axis 703 of the emissions pattern 700 in this instance is aligned with the x-axis, as is the slit 601b, and the photodiodes 603c and 603d are approximately aligned as well along their longest dimensions. FIG. 9 shows how a shaped LED output may provide a more uniform reflective optical power distribution on the detector photodiodes 603 after reflecting off the code disk or track. Note that the photodiodes 603c and 603d receive substantially consistent light intensity across their longest dimensions consistent with the highly oblong shape of emissions pattern 700.

The example of FIG. 9 assumes a rotary code disk, so the other photodiodes 603a,b,e,f have more y-axis variation and, thus, may receive less consistent reflections than do the other photodiodes 603c and 603d. Nevertheless, total consistency may be increased relative to the point source LED pattern described above with respect to FIG. 6.

Note in this illustration the system shows a rotary system with a fixed diode detector array. The concepts described support either rotary or linear and support either a fixed diode pattern or a programmable diode array.

As noted above, some photodiode arrays may be programmable so that individual ones of the photodiodes may be assigned to one of four quadrature states or OFF, and summing and amplification may be applied as well to further refine the amplitudes and phases of the sinusoids. Programmable photodiode arrays may be used to compensate for LEDs having circular emissions patterns by assigning and weighting the different photodiodes to reduce the effects of the two-dimensional falloff. As further noted above, a programmable photodiode array may be used with embodiments of the present disclosure having a shaped LED and, in some instances, the shaped LED may increase precision by aligning a longest dimension of a photodetector and a slit with a major dimension of an oblong emissions pattern. Additionally, various embodiments of the present disclosure may be used with a photodiode array that is non-programmable.

The various embodiments herein are not drawn to scale, and it is understood that various dimensions may be changed for different embodiments as appropriate. One particular dimensional relationship is that of the slits of the target object versus a size of individual photodetectors. In the case wherein a slit width is much larger (more than an order of magnitude larger) than a corresponding dimension of a photodiode, the emissions pattern as it falls upon the photodiode array may be understood as effectively elliptical. However, in a case wherein the slit width is much smaller (e.g., more than an order of magnitude smaller) than the photodiode geometry, the relation of the emissions pattern to the photodiodes becomes a mathematical function amenable only to simulation and experimentation. Nevertheless, the inventors have discovered that shaped LEDs, especially those with elliptical emissions patterns, increase precision in both scenarios.

Various embodiments may provide one or more advantages over some historical reflective optical encoders using point source LEDs having circular emissions patterns as well as over transmissive optical encoders. As noted above, embodiments using a light source having a non-circular emissions pattern may align the dimensions of the emissions pattern, the slits, and the photodetectors to reduce radial falloff along a dimension of the photodetectors, thereby increasing precision. Such feature may also decrease complexity of simulations and experimentation involving emissions pattern compensation, since an oblong emissions pattern may in some instances make major dimension radial falloff substantially reduced or near zero.

Additionally, various embodiments may increase a precision of a reflective optical detector design while preserving low cost and small size characteristics. This may make some reflective optical encoder designs competitive with some transmissive optical encoder designs which are more expensive and larger.

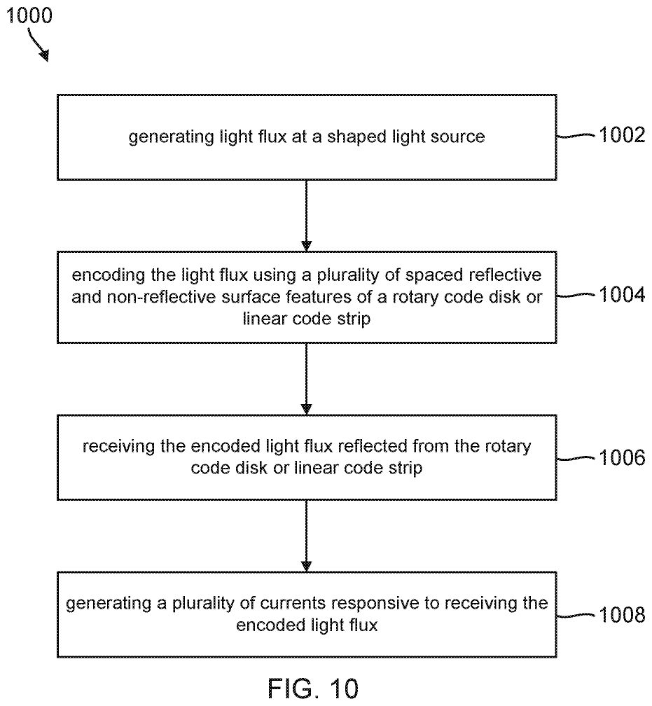

Referring now to FIG. 10, there is illustrated a block diagram of a method 1000 for operating a reflective optical encoder according to an embodiment of the present disclosure. For ease of illustration, reference will be made to the embodiments described above with respect to FIGS. 1-9.

At action 1002, the reflective optical encoder generates light flux at a shaped light source. An example of a shaped light source includes an EEL or other appropriate light source that has a non-circular emissions pattern. One particular example is described above with respect to FIGS. 7-9, where the emissions pattern is elliptical.

At action 1004, the system encodes the light flux using a plurality of spaced reflective and non-reflective surface features. An example may include the rotary code disk of FIG. 3 or the linear code strip of FIG. 4, both of which have tracks illustrated. The light flux is encoded as the motion of the target object causes the light to be reflected or not reflected.

At action 1006, the system receives the encoded light flux reflected from the target object. For instance, an array of photodiodes may be arranged at a surface of an IC chip, such as shown in FIGS. 1 and 2, where the light reflected from the target object impinges upon the array of photodiodes. Each of the photodiodes may be assigned to four particular quadrature states or OFF either in a fixed or programmable pattern. Furthermore, some embodiments may include the photodiodes being assigned weights that may be fixed or programmable.

At action 1008, the array of photodiodes generates a plurality of currents responsive to receiving the encoded light flux. As noted above, each of the particular photodiodes may be assigned to a particular quadrature state or OFF. Therefore, at a given time some of the photodiodes are contributing current to their respective quadrature states. That current may or may not be converted to voltage, and in any event is information representing the encoding of the light flux.

The scope of embodiments is not limited only to the series of actions shown in FIG. 10. Rather, various embodiments may add, omit, rearrange, or modify one or more the actions. For instance, some embodiments process the information from the currents or voltages by converting them into digital data and processing the digital data to precisely identify a motion or position of the target object. Thus, the optical encoder systems described herein, such as those illustrated above at FIGS. 1 and 2, may include computer processing circuitry configured to convert signals to digital data and then to process that digital data for a desired use.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

What is claimed is:

1. An optical encoder system, comprising:
a light emitter configured to emit a light flux;
a plurality of photodetectors in an array, wherein each photodetector is operable to generate a current in response to the light flux; and
a target object positioned to reflect the light flux onto the plurality of photodetectors;
wherein the light emitter is configured to produce a non-circular pattern of the light flux.

2. The optical encoder system of claim 1, wherein the light emitter comprises an Elliptical Emissions LED (EEL).

3. The optical encoder system of claim 1, wherein the light emitter comprises a light emitting diode having a rectangular-shaped aperture.

4. The optical encoder system of claim 1, wherein the light emitter is configured to produce an elliptical pattern of the light flux, wherein a dimension of a major axis of the elliptical pattern is at least three times a size of a dimension of a minor axis of the elliptical pattern.

5. The optical encoder system of claim 1, wherein the light emitter is configured to produce an elliptical pattern of the light flux, further wherein a major axis of the elliptical pattern is aligned with a longest dimension of slits of the target object.

6. The optical encoder system of claim 1, wherein the target object comprises a plurality of reflective slits, further wherein a slit width is at least an order of magnitude smaller than a minor axis of an elliptical pattern produced by the light emitter.

7. The optical encoder system of claim 1, wherein each photodetector has a changeable state assignment;
and wherein the optical encoder system is configured to route each one of the currents according to a respective changeable state assignment.

8. The optical encoder system of claim 1, wherein the target object comprises a rotary code disk or a linear code strip.

9. An optical encoder system comprising:
means for emitting a light flux having a non-circular pattern;
means for reflecting and encoding the light flux according to a plurality of spaced surface features;
means for generating electrical currents in response to detecting the encoded light flux; and
means for calculating motion or position in response to the generated electrical currents.

10. The optical encoder system of claim 9, wherein the emitting means comprises an Elliptical Emissions LED (EEL).

11. The optical encoder system of claim 9, wherein the emitting means comprises a light-emitting diode having a rectangular-shaped aperture.

12. The optical encoder system of claim 9, where in the emitting means is configured to produce an elliptical pattern of the light flux, wherein a dimension of a major axis of the elliptical pattern is at least three times a size of a dimension of a minor axis of the elliptical pattern.

13. The optical encoder system of claim 9, wherein the emitting means is configured to produce an elliptical pattern of the light flux, further wherein a major axis of the elliptical pattern is aligned with a longest dimension of the surface features.

14. The optical encoder system of claim 9, wherein the surface features comprise a plurality of reflective slits, further wherein a slit width is at least an order of magnitude smaller than a minor axis of an elliptical pattern produced by the emitting means.

15. The optical encoder system of claim 9, wherein the calculating means comprises an integrated circuit chip, and wherein the emitting means is disposed on top of the integrated circuit chip.

16. The optical encoder system of claim 9, wherein the calculating means comprises an integrated circuit chip, and wherein the emitting means is disposed to a side the integrated circuit chip.

17. The optical encoder system of claim 9, wherein the reflecting and encoding means comprises a rotary code disk or a linear code strip.

18. The optical encoder system of claim 9, wherein the generating means comprises an array of photodetectors.

19. The optical encoder system of claim 18, wherein each photodetector has a changeable state assignment;
and wherein the optical encoder system is configured to route each one of the currents according to a respective changeable state assignment.

20. A method for operating an optical encoder system comprising:
generating light flux at a shaped light source;
encoding the light flux using a plurality of spaced reflective and non-reflective surface features of a rotary code disk or linear code strip;
receiving the encoded light flux reflected from the rotary code disk or linear code strip; and
generating a plurality of currents responsive to receiving the encoded light flux.
